(19) United States
(12) Patent Application Publication
(10) Pub. No.: US 2003/0093917 A1
(43) Pub. Date: May 22, 2003

(54) Apparatus and methods for processing electronic component precursors

(76) Inventor: Gerald N. DiBello, West Chester, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/301,322

(22) Filed: Nov. 21, 2002

Related U.S. Application Data
(60) Provisional application No. 60/331,733, filed on Nov. 21, 2001.

(51) Int. Cl. F26B 5/00; F26B 21/00; F26B 21/14; F26B 21/06

(52) U.S. Cl. 34/443; 34/445; 34/446; 34/282; 34/72; 34/73; 34/523

(57) ABSTRACT

Methods and apparatus for processing an electronic component precursor comprising the steps of contacting a carrier gas with a process chemical stream to entrain the process chemical in the carrier gas thereby forming a fluid stream and injecting at least a portion of additional process chemical into the fluid stream to form a localized region of increased concentration of process fluid is provided. The methods and apparatus also provide injecting a portion of additional carrier gas into the fluid stream to form a diluted region of decreased concentration of process fluid is also provided. The methods and apparatus further provide controlling the concentration of process chemical in the localized region as well as in the fluid stream. Apparatus comprising a first manifold operatively associated with a carrier gas source for receiving a fluid stream formed by the carrier gas and a second manifold in fluid communication with the first manifold for receiving a process chemical and for injecting the process chemical into the fluid stream thereby forming a localized region of increased concentration of process chemical is provided.

### CROSS-REFERENCE TO RELATED APPLICATIONS

This claims the benefit of priority under 35 U.S.C. §119(e) from provisional U.S. Application Serial No. 60/331,733, filed on Nov. 21, 2001, which is incorporated herein by reference in its entirety.

### FIELD OF THE INVENTION

The present invention is directed to apparatus and methods for wet processing electronic component precursors. More specifically, this invention relates to apparatus and methods for drying electronic component precursors, including semiconductor wafers, with a fluid stream having a controlled concentration of a process chemical.

### BACKGROUND OF THE INVENTION

Wet processing of electronic components, such as semiconductor wafers, flat panels, and other electronic component precursors, is used extensively during the manufacture of integrated circuits. Preferably, wet processing is carried out to prepare the electronic component for processing steps such as diffusion, ion implantation, epitaxial growth, chemical vapor deposition, hemispherical silicon grain growth, oxide film growth, metal deposition, dielectric deposition, or combinations thereof. During wet processing, the electronic components are contacted with a series of processing solutions. The processing solutions may be used, for example, to etch, remove photoresist, clean, or rinse the electronic components. See, e.g., U.S. Pat. Nos. 4,577,650; 4,740,249; 4,738,272; 4,856,544; 4,633,893; 4,778,532; 4,917,123; and EP 0 233 184, assigned to a common assignee, as well as Burkman et al., Wet Chemical Processes-Aqueous Cleaning Processes, pg 111-151 in Handbook of Semiconductor Wafer Cleaning Technology (edited by Werner Kern, Published by Noyes Publication Parkridge, N.J. 1993), the disclosures of which are herein incorporated by reference in their entirety.

There are various types of systems available for wet processing. For example, the electronic components may be processed in a single vessel system closed to the environment (such as a Omni™ system supplied by Mattson Technology, Inc.), a single vessel system open to the environment, a multiple open bath system (e.g., wet bench) having a plurality of baths open to the atmosphere (such as the AWP™ system supplied by Mattson Technology, Inc.), or single-wafer processors such as the Aquaspin™ by Dai Nippon Screen, the Millennium™ by Semitool or the Sahara™ by Verteq).

Following processing, the electronic components are typically dried. Drying of the semiconductor substrates can be done using various methods, with the goal being to ensure that there is no contamination created during the drying process. Liquid droplets of wet processing solutions and/or water, even if pure, left on the electronic component to evaporate may undesirably leave watermarks. Furthermore, impurities present in the wet processing solution present a potential source of contamination. Such impurities undesirably leave marks (e.g., watermarks) or other residues on the surfaces of the electronic component precursors. By removing liquid droplets during drying, watermarks are avoided and residual impurities present in the liquid droplets do not remain on the surfaces of the electronic component precursors when the liquid droplets evaporate.

Methods of drying include evaporation, centrifugal force in a spin-rinse-dry system, and steam or chemical drying of wafers. Examples of such methods, and apparatus for carrying out such methods, are disclosed in U.S. Pat. Nos. 4,778,532; 4,911,761; 5,271,774; and EP Patent No. 0385536. With reference to a concentration of drying fluid or process chemical, essentially fixed drying conditions are provided by existing drying apparatus and methods. Some methods and apparatus provide fixed amounts of diluted process chemical, relying on saturating a carrier gas with the process chemical. Drying methods that utilize a fixed amount of diluted process chemical, however, are limited in their drying effectiveness at contact points where the electronic precursors are held in the equipment. On the other hand, drying methods that utilize solely a high concentration of process chemical source are costly by requiring large vaporizers and using more chemical than is actually necessary at certain points during the drying process. Furthermore, environmental concerns related to the use of particular process chemicals may necessitate that wet processing systems have the controlled capability to vary levels of process chemicals during processing steps. As such, there is a continued need for improved apparatus and methods for drying electronic components. In particular, there is a need for apparatus and methods for processing electronic component precursors, which offer flexibility in drying conditions. In addition, there is a need for apparatus and methods for processing electronic component precursors with a fluid stream having a controlled concentration of process chemical.

### SUMMARY OF THE INVENTION

The present invention provides apparatus and methods for wet processing electronic component precursors with a fluid stream. The apparatus and methods enable the electronic component precursors to be processed with fluid streams having a controlled concentration of process chemical. In particular, the apparatus and methods enable the precursors to be treated with a fluid stream with localized regions having an increased concentration of process chemical. In addition, the apparatus and methods enable to the precursors to be treated with a fluid stream with a controlled concentration of process chemical, for example, a concentration diluted to below saturation. Further, the apparatus and methods provide a fluid stream with diluted regions having a decreased concentration of process chemical.

In one of its aspects, the present invention relates to methods for processing an electronic component precursor wherein a carrier gas is contacted with a process chemical to entrain the process chemical in the carrier gas and form a fluid stream. Subsequently, at least a portion of additional process chemical is then injected into the fluid stream to form a localized region of increased concentration of process fluid in the fluid stream The concentration of process chemical in the localized region can be controlled to achieve desired drying conditions. In one example, the additional process chemical is injected into the fluid stream at selected intervals which permits drying conditions to be varied to achieve high concentrations of processing chemical during critical steps and then return to lower concentrations of processing chemical in the fluid stream. In another example, the fluid stream is passed through a condenser to condense the process chemical from the carrier gas and form a condensed process chemical. The condensed process chemical is used to create a localized region of increased concentration of process chemical in the fluid stream. The condensed process chemical is optionally vaporized upon or after injection into the fluid stream. In further embodiment, purified process chemical is injected into the fluid stream at discrete intervals to form a localized region being controlled in concentration by the injection interval.

In a further aspect of the present invention, the concentration of a fluid stream comprising a process chemical entrained in a carrier gas is controlled to achieve concentrations below saturation. An analyzer measures the concentration of process chemical in the fluid stream and controls the flow rate of the carrier gas to achieve a desired concentration. Alternatively, for example, the concentration of the process gas in the fluid stream can be controlled by regulating the flow rate of the process chemical.

In yet a further example, a portion of the carrier gas is injected into the fluid stream to form a localized diluted region of decreased concentration of process chemical. The concentration of process chemical in the diluted region can be controlled to achieve desired conditions. In one example, the carrier gas is injected into the fluid stream at selected intervals which permits drying conditions to be varied to achieve low concentrations of process chemical during appropriate steps and then return to higher concentrations of process chemical in the fluid stream.

In another of its aspects, the present invention relates to apparatus for processing electronic component precursors comprising a mixing module in fluid communication with a carrier gas source for entraining a process chemical, such as isopropyl alcohol, in a carrier gas, such as nitrogen, to form a fluid stream. A sparger is optionally provided to facilitate entraining the process chemical within the carrier gas. A first manifold is provided in fluid communication with the mixing module. The first manifold can be positioned to supply the fluid stream to a condenser and an accumulator for collecting a condensed process chemical. Alternatively, the first manifold can be positioned to supply the fluid stream to a second manifold. The second manifold receives the fluid stream from the first manifold and enables at least a portion of the condensed process chemical to be mixed with the fluid stream. A chamber is optionally provided for receiving fluid stream from the second manifold. A vaporizer is optionally operatively associated with the second manifold for vaporizing the condensed process fluid. An analyzer is optionally provided to measure concentration of the process chemical in the fluid stream and used in conjunction with a controller to achieve desired processing conditions.

### BRIEF DESCRIPTION OF THE DRAWINGS

The numerous objects and advantages of the present invention may be better understood by those skilled in the art by reference to the accompanying detailed description and the following drawing, in which:

FIG. 1 is a schematic representation of an apparatus for processing electronic component precursors in accordance with the present invention;

FIG. 2 is a schematic representation of an alternate embodiment of an apparatus for processing electronic component precursors in accordance with the present invention;

FIG. 3 is a schematic representation of another alternate embodiment of an apparatus for processing electronic component precursors in accordance with the present invention; and

FIG. 4 is a schematic representation of still another alternate embodiment of an apparatus for processing electronic component precursors in accordance with the present invention.

### DETAILED DESCRIPTION OF ILLUSTRATIVE EMBODIMENTS

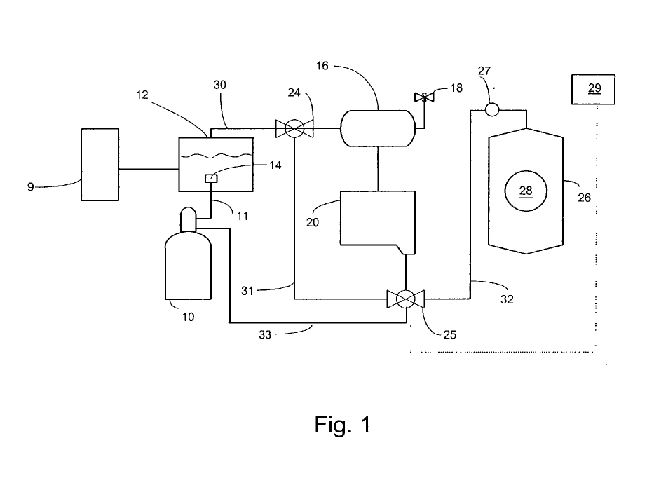

The present invention provides apparatus and methods for processing electronic component precursors. The present invention further provides apparatus and methods for drying electronic component precursors during wet processing thereof. The precursors are dried by a drying fluid stream having a controlled concentration of a process chemical. Referring to FIG. 1, a process chemical is passed from a process chemical source 9 to a mixing module 12. In addition, a carrier gas is passed from a gas source 10 through gas line 11 to the mixing module 12 to contact the carrier gas with the process chemical, thereby entraining the process chemical within the carrier gas and forming a fluid stream. The fluid stream is then directed to a first manifold 24 via gas line 30. When the first manifold 24 is in a first position, the fluid stream is directed through a second manifold 25 to a chamber 26 housing the electronic component precursors 28 to effectuate processing of the precursors 28. The fluid stream is passed from the first manifold 24 to the second manifold 25 by gas line 31 and from the second manifold 25 to the chamber 26 through gas line 32. One or more of gas lines 11, 30, 31, and 32 are preferably heated by, for example, wrapping the gas lines with heating tape. If needed, the gas lines are maintained at a temperature sufficient to ensure that the process chemical is vaporized prior to reaching the chamber 26. For example, gas lines 11, 30, 31, and/or 32 can be heated to a temperature of about 90-120° C.

When the first manifold 24 is in a second position, the fluid stream is passed from manifold 24 through a condenser 16 to produce a condensed process chemical which can be stored in an accumulator 20. Accumulator 20 also serves to allow the condensed process chemical to be mixed with, or injected into, the fluid stream passing through gas lines 31 and 32. In one embodiment, the condensed process chemical from the accumulator 20 is continually mixed with the fluid stream to provide a fluid stream having a relatively constant and increased concentration of process chemical. Alternatively, portions of the condensed process chemical from the accumulator 20 can be introduced into the fluid stream at selected intervals. By injecting additional process chemical from the accumulator 20 into the carrier fluid stream at selected intervals (e.g., during critical points of the process), the fluid stream is provided with localized regions having an increased concentration of the process chemical. Critical points of the process include, for example, when the electronic components first emerge from a rinsing fluid, when the electronic components and a mechanical means used to hold the components first emerge from a rinsing fluid, when the electronic components are completely displaced of rinsing fluid, and when the surrounding apparatus, vessel, holding mechanisms and all other hardware and surfaces touching the rinsing and drying fluids need to be purged of rinsing fluid to prevent recontamination of the electronic components.

In a further aspect of the present invention, the concentration of the fluid stream is controlled to achieve concentrations of process chemical below saturation. An analyzer 27 measures the concentration of process chemical in the fluid stream and the flow rate of the carrier gas is regulated by controller 29 to achieve a desired concentration. Alternatively, for example, the concentration of the process gas in the fluid stream can be controlled by regulating the flow rate of the process chemical using controller 29. Further, to provide a fluid stream having a diluted region of process chemical, the carrier gas is passed from gas source 10 through gas line 33 to the second manifold 25.

The terminology “electronic component precursor,” as used herein, includes for example semiconductor wafers, flat panels, and other components used in the manufacture of electronic components (i.e., integrated circuits); CD ROM disks; hard drive memory disks; or multichip modules.

It is meant that a “carrier gas” is capable of entraining a process chemical to form a fluid stream. A carrier gas can equivalently be referred to as a diluent gas. One example of a carrier gas is nitrogen, but it is possible that other gas streams, available from their use during other wet processing steps, can be used.

By “dry” or “drying” it is meant that the electronic component precursors are preferably made substantially free of liquid droplets on the usable portion of the electronic component precursors. Impurities present in the wet processing solution present a potential source of contamination. Such impurities undesirably leave marks (e.g., watermarks) or other residues on the surfaces of the electronic component precursors. By removing liquid droplets during drying, impurities present in the liquid droplets do not remain on the surfaces of the electronic component precursors when the liquid droplets evaporate. However, it is also contemplated that drying may simply involve removing a processing or rinsing fluid. Even pure liquid droplets, i.e. those without contamination, may undesirably leave watermarks if allowed to dry or evaporate on the surface. Accordingly, drying as used herein encompasses removal of processing or rinsing fluids even when such removal leaves a film, or portion of a film, on the surfaces of the electronic component precursors, provided that subsequent removal of the film does not deleteriously affect the electronic component precursors.

The terminology “wet processing” or “wet process” as used herein means the electronic component precursors are contacted with one or more liquids (hereinafter referred to as “process liquids” or “process solutions”) to process the electronic component precursors in a desired manner. For example, it may be desired to treat the electronic component precursors to clean, etch, or remove photoresist from the surfaces of the electronic component precursors. It may also be desired to rinse the electronic component precursors between such treatment steps.

Wet processing may also include steps where the electronic component precursors are contacted with other fluids, such as a gas, a vapor, a liquid mixed with a vapor or gas, or combinations thereof. As used herein, the term “process fluid” includes liquids, gases, liquids in their vapor phases, or combinations thereof. The terminology “vapor” as used herein is meant to include partially vaporized liquid, saturated vapor, unsaturated vapor, supersaturated vapor or combinations thereof.

Semiconductor fabrication is described generally, for example, in P. Gise et al., Semiconductor and Integrated Circuit Fabrication Techniques (Reston Publishing Co., Reston, Va. 1979), the disclosure of which is incorporated herein by reference in its entirety.

Referring again to FIG. 1, the process chemical source 9 and the gas source 10 are any containers suitable for containing the process chemical and carrier gas, respectively. For example, the carrier gas can be stored in external tanks which are in fluid communication with other components of the apparatus via fluid lines, pipes, or tubing. In particular, the carrier gas can be stored in compressed form in a suitable compressed gas cylinder.

The process chemical source 9 and gas source 10 are in fluid communication with the mixing module 12. In one particular embodiment, the process chemical is a liquid and the mixing module 12 enables the carrier gas to bubble through the process chemical. The height of the mixing module 12 is selected, in part, to help insure that the carrier gas is in contact with the process chemical within the mixing module 12 for a time sufficient to entrain a suitable amount of process chemical within the carrier gas. Other factors that affect the amount of process chemical entrained within the carrier gas include the temperature of the carrier gas, the temperature of the process chemical, the surface area of carrier gas in contact with the process chemical, and the pressure within the mixing module. Accordingly, the mixing module 12 optionally comprises a heater for heating the process chemical to increase the concentration of process chemical in the carrier gas.

The mixing module 12 is optionally provided with a sparger 14 to facilitate bubbling of the carrier gas through the process chemical. The sparger 14 increases the surface area of carrier gas that is in contact with the process chemical, thereby enabling the process chemical to be more easily entrained within the carrier gas. In one particular embodiment, the sparger 14 is formed from a sintered polytetrafluoroethylene (PTFE) material, such as that described in U.S. Pat. No. 5,776,296, which is hereby incorporated by reference herein in its entirety.

Examples of process chemicals which may be employed are alcohols such as methanol, ethanol, 1-propanol, isopropanol, n-butanol, secbutanol, tertbutanol, or tert-amyl alcohol, acetone, acetonitrile, hexafluoroacetone, nitromethane, acetic acid, propionic acid, ethylene glycol mono-methyl ether, difluoroethane, ethyl acetate, isopropyl acetate, 1,1,2-trichloro-1,2,2-trifluoroethane, 1,2-dichloroethane, trichloroethane, perfluoro-2-butyltetrahydrofuran, perfluoro-1,4-dimethylcyclohexane or combinations thereof. Preferably, the process chemical is a C₁ to C₆ alcohol, such as for example methanol, ethanol, 1-propanol, isopropanol, n-butanol, secbutanol, tertbutanol, tert-amyl alcohol, pentanol, hexanol or combinations thereof.

When the first manifold 24 is in its second position, the mixing module 12 is in fluid communication with the condenser 16, thereby enabling the carrier gas with the entrained process chemical to be passed from the mixing module 12 through the condenser 16. The condenser 16 causes the process chemical to condense out of the carrier gas to form the condensed process chemical. First manifold 24 may be operated to supply both manifold 25 and the condenser 16 simultaneously, if desired. A valve 18 is optionally operatively connected to the condenser 16 to enable the carrier gas to pass from the condenser 16. The accumulator 20 is in fluid communication with the condenser 16 for receiving and collecting the condensed process chemical. The accumulator 20 also functions to supply the condensed process chemical to the second manifold 25.

When the first manifold 24 is in its first position, the second manifold 25 receives the carrier gas with the entrained process chemical from the first manifold 24 via gas line 31. When the second manifold 25 is in a first position, the second manifold 25 is in fluid communication with the process chamber 26 for supplying the fluid stream from the first manifold 24 to the chamber 26. In a preferred embodiment, the fluid stream is introduced into the chamber 26 through the top of the chamber 26. The terminology “process chamber” and “reaction chamber,” as used herein, refer to vessels (enclosed or open to the atmosphere), baths, wet benches and other reservoirs suitable for wet processing electronic components. The terminology “single vessel,” refers to any wet processing system in which the electronic components are maintained in one processing chamber during the entire wet processing sequence.

When the second manifold 25 is in a second position, condensed process chemical from the accumulator 20 is mixed with the fluid stream from manifold 24 to form a concentrated fluid stream. Accordingly, second manifold 25 may simultaneously receive both the fluid stream from the first manifold 24 and condensed process chemical from accumulator 20. In one particular embodiment, the second manifold 25 injects selected amounts of the condensed process chemical into the fluid stream at selected intervals. Injection of the condensed process chemical into the fluid stream produces a drying fluid stream having localized regions with increased concentration of process chemical. The concentration of the resultant fluid stream is measured by concentration analyzer 27. The analyzer is used in conjunction with a controller 29 to achieve desired concentrations of process chemical during certain periods of time. To achieve a localized region of high concentration of process chemical, in one instance, the flow of condensed process chemical from the accumulator 20 is regulated by the controller.

Furthermore, the controller 29 can control the concentration of process chemical in the fluid stream by regulating the flow rate, for example, of one of either the process chemical from the chemical source 9 or the carrier gas from the gas source 10.

When second manifold 25 is in a third position, the carrier gas from source 10 through gas line 33 is mixed with the fluid stream from the first manifold 24 to form a diluted region in the fluid stream. Diluent gases from other parts of the wet processing system also may be connected to second manifold 25 for use in forming a diluted region in the fluid stream.

A vaporizer or heater is optionally operatively associated with the second manifold 25 for vaporizing the condensed process chemical upon, or shortly after, injection of the condensed process chemical into the fluid stream. Vaporization of the condensed process chemical further facilitates production of a fluid stream having localized regions with increased process chemical concentration.

The present invention may be carried out using a process chamber 26 comprising generally any of the known wet processing systems including, for example, multiple bath systems (e.g., wet bench) and single processing chamber systems (open or closable to the environment). See, e.g., Chapter 1: Overview and Evolution of Semiconductor Wafer Contamination and Cleaning Technology by Werner Kern and Chapter 3: Aqueous Cleaning Processes by Don C. Burkman, Donald Deal, Donald C. Grant, and Charlie A. Peterson in Handbook of Semiconductor Wafer Cleaning Technology (edited by Werner Kern, Published by Noyes Publication Parkridge, N.J. 1993), and “Wet Etch Cleaning” by Hiroyuki Horiki and Takao Nakazawa in Ultraclean Technology Handbook, Volume 1, (edited by Tadahiro Ohmi published by Marcel Dekker), the disclosures of which are herein incorporated by reference in their entirety.

In one embodiment of the invention, the electronic component precursors 28 are housed in a single processing chamber system. Preferably, single processing chamber systems such as those disclosed in U.S. Pat. Nos. 4,778,532, 4,917,123, 4,911,761, 4,795,497, 4,899,767, 4,984,597, 4,633,893, 4,917,123, 4,738,272, 4,577,650, 5,571,337 and 5,569,330, the disclosures of which are herein incorporated by reference in their entirety, are used. Preferred commercially available single processing chamber systems are Omni™ and DTT® vessels such as those manufactured by Mattson Technology, Inc., and FL820L manufactured by Dainippon Screen. Such systems are preferred because foreign gas and contamination levels can be more readily controlled.

In operation, the apparatus is used to process electronic component precursors by placing the electronic component precursors 28 in the process chamber 26 and introducing the desired fluid streams into the chamber 26 through a valve or injection port. One or more of the desired process fluid streams is formed having an increased concentration of a process chemical as follows. A process chemical is passed from the process chemical source 9 to the mixing module 12. A carrier gas is then passed from carrier gas source 10 to mixing module 12 via gas line 11. The carrier gas contacts the process chemical in the mixing module 12, thereby entraining the process chemical within the carrier gas to form a fluid stream. The process chemical can be present in the carrier gas at a concentration below saturation (e.g., about 0.1 ppm to about 12 weight percent) or near saturation, given the temperatures, pressures, and flow rates used. Alternatively, the carrier gas can be turned off and about 100% process chemical used. The fluid stream is then passed to the first manifold 24 via gas line 30. During the time when drying fluid is not required in the process vessel 26, the first manifold 24 is typically positioned to pass the fluid stream to condenser 16 and accumulator 20, and accumulate condensed process chemical in the accumulator 20. Prior to processing the electronic components precursors 28 with the fluid stream, and after a sufficient amount of condensed process chemical has been collected, the first manifold 24 is positioned to pass the fluid stream to the second manifold 25. The second manifold 25 is maintained to pass the fluid stream to the chamber 26. When the electronic component precursors 28 are to be contacted with a concentrated fluid stream (e.g., at critical points in the process), the second manifold 25 enables a portion of the condensed process chemical to mix with the fluid stream and form the concentrated fluid stream. When processing with the concentrated fluid stream is complete, the second manifold 25 is again positioned to pass only the fluid stream to the chamber 26. When processing with the fluid steam is complete, first manifold 24 can be operated to allow flow to the condenser 16 so that liquid process chemical can be collected in accumulator 20 for later use.

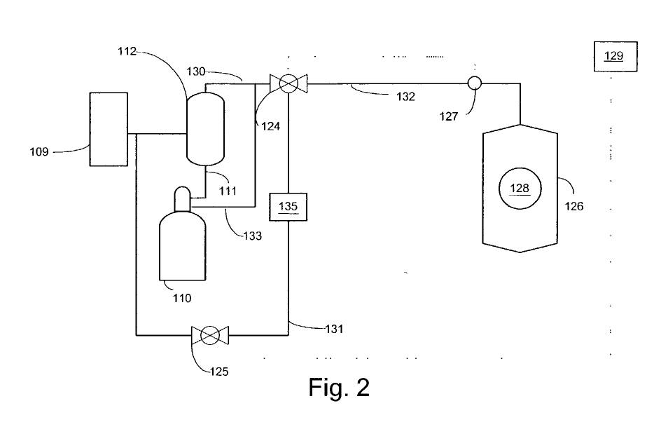

An alternate embodiment of an apparatus in accordance with the present invention is depicted schematically in FIG. 2. Referring to FIG. 2, a process chemical is passed from a process chemical source 109 to a gas-liquid contactor 112. In addition, a carrier gas is passed from a gas source 110 through gas line 111 to the contactor 112 to form a fluid stream. The fluid stream is then directed to a manifold 124. The process chemical source 109 is also in direct fluid communication with the manifold 125. When the manifold 124 is in a first position, the manifold 124 supplies the fluid stream from the contactor 112 to the chamber 126. When the manifold 124 is in a second position, the manifold 124 supplies process fluid from the process chemical source 109 through manifold 125 to the chamber 126. A vaporizer 135 is optionally provided for vaporizing the process chemical prior to introducing the process chemical into the fluid stream for flowing into the chamber 126. In addition, a purifier and/or filter is optionally positioned between the process chemical source 109 and the vaporizer 135 for purifying and/or filtering the process chemical. Heat tracing is optionally used on line 132 for maintaining a vaporized state of process chemical. Further, when the manifold 124 is in a third position, the manifold 124 supplies a mixture of the fluid stream from the contactor 112 and process chemical from the process chemical source 109 to the chamber 126. The concentration of the resultant fluid stream is measured by concentration analyzer 127. The analyzer is used in conjunction with a controller 129 to achieve desired concentrations of process chemical during certain periods of time. To achieve a localized region of high concentration of process chemical, in one instance, the flow of process chemical from the chemical source 109 through second manifold 125 is regulated by the controller 129.

Furthermore, the controller 129 can control the concentration of process chemical in the fluid stream by regulating the flow rate, for example, of one of either the process chemical from the chemical source 109 or the carrier gas from the gas source 110 through first manifold 124.

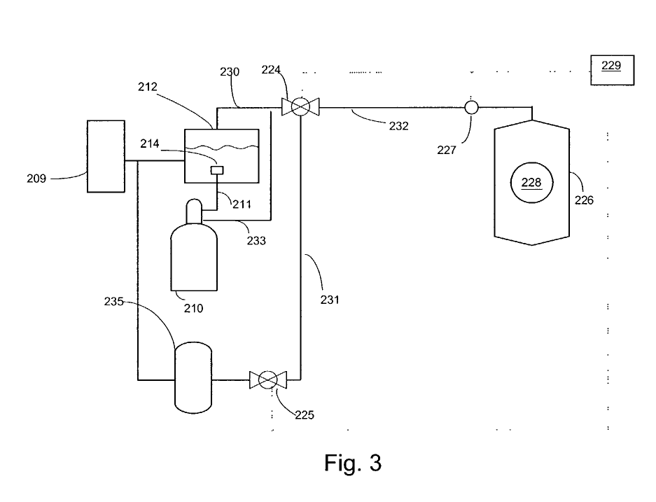

In another example, the carrier gas from source 110 by-passes contactor 112 through gas line 133 and is mixed with the fluid stream from the first manifold 124 to form a diluted region in the fluid stream. Diluent gases from other parts of the wet processing system also may be connected to first manifold 124 for use in forming a diluted region in the fluid stream. Yet another alternate embodiment of an apparatus in accordance with the present invention is depicted schematically in FIG. 3. The apparatus depicted in FIG. 3 is similar to the apparatus depicted in FIG. 1 except that the process chemical source 209 can be used to supply the gas liquid contactor 212 and/or a vaporizer 235. The gas liquid contactor is preferably used to provide a low concentration process chemical, while the vaporizer 235 is preferably used to provide a high concentration process chemical. The process chemical streams generated by the contactor 212 and the vaporizer 235 can be used independently to process the precursors 228. Alternatively, the process chemical streams generated by the contactor 212 and the vaporizer 235 can be combined together, by adjusting manifolds 225 and 224, to produce a process chemical stream having an intermediate concentration. The concentration of the resultant fluid stream is measured by concentration analyzer 227. The analyzer is used in conjunction with a controller 229 to achieve desired concentrations of process chemical during certain periods of time. To achieve a localized region of high concentration of process chemical, in one instance, the flow of process chemical from the chemical source 209 through second manifold 225 is regulated by the controller 229.

Furthermore, the controller 229 can control the concentration of process chemical in the fluid stream by regulating the flow rate, for example, of one of either the process chemical from the chemical source 209 or the carrier gas from the gas source 210 through first manifold 224.

In another example, the carrier gas from source 210 by-passes contactor 212 through gas line 233 and is mixed with the fluid stream from the first manifold 224 to form a diluted region in the fluid stream. Diluent gases from other parts of the wet processing system also may be connected to first manifold 224 for use in forming a diluted region in the fluid stream.

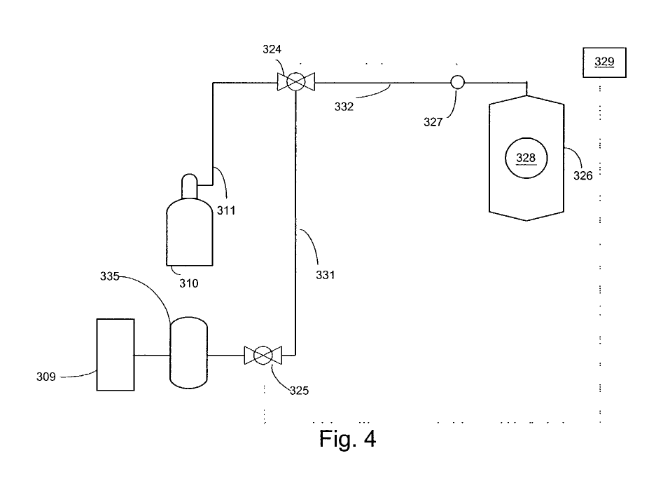

Still another embodiment of an apparatus in accordance with the present invention is depicted schematically in FIG. 4. In the embodiment of FIG. 4, liquid solvent or drying fluid is supplied by process chemical source 309 to a vaporizer 335. Manifold 325 can then be adjusted so that vaporizer 335 supplies a 100% drying vapor to the vessel 326 for processing the precursors 328. A gas source 310 and manifold 324 are also provided for supplying a carrier gas to the vessel 326. The drying vapor from the vaporizer 335 and the carrier gas from the gas source 310 can be used independently to process the precursors 328. Alternatively, the drying vapor and carrier gas can be combined together, by adjusting manifolds 324 and 325. The concentration of the resultant fluid stream is measured by concentration analyzer 327. The analyzer is used in conjunction with a controller 329 to achieve desired concentrations of process chemical during certain periods of time. To achieve a localized region of high concentration of process chemical, in one instance, the flow of process chemical from the chemical source 309 through second manifold 325 is regulated by the controller 329.

Furthermore, the controller 329 can control the concentration of process chemical in the fluid stream by regulating the flow rate, for example, of the carrier gas from the gas source 210 through first manifold 224. Diluent gases from other parts of the wet processing system also may be connected to first manifold 324 for use in forming a diluted region in the fluid stream. In one aspect of the present invention, the electronic component precursors 28 are maintained in a single process chamber 26 during the entire wet chemical treatment process (e.g., cleaning, rinsing and drying). In this aspect of the invention, the electronic component precursors 28 are placed in the process chamber 26 and the surfaces of the precursors 28 are contacted with one or more process chemicals for a selected period of time without removing the precursors 28 from the chamber 26 (i.e., direct replacement). Alternatively, the precursors 28 can be lifted from chamber 26 between process steps.

The electronic components may be contacted with any number of reactive chemical process fluids (e.g., gas, liquid, vapor or any combination thereof) to achieve a desired result. For example, the electronic components may be contacted with reactive chemical process fluids used to etch (hereinafter referred to as etching fluids), grow an oxide layer (hereinafter referred to as oxide growing fluids), to remove photoresist (hereinafter referred to as photoresist removal fluids), to enhance cleaning (hereinafter referred to as cleaning fluids), or combinations thereof. The electronic components may also be rinsed with a rinsing fluid at any time during the wet processing method. Preferably, the reactive chemical process fluids and rinsing fluids are liquids.

The reactive chemical process fluids useful in the present invention may contain one or more chemically reactive agents to achieve the desired surface treatment. Preferably, the concentration of such chemically reactive agents will be greater than about 10 ppm and more preferably greater than 5%, based on the weight of the reactive chemical process fluid. However, in the case of ozone, generally the concentration is equal to or greater than about 10 ppm and more preferably from about 10 ppm to about 250 ppm. Examples of chemically reactive agents include for example hydrochloric acid or buffers containing the same, ammonium hydroxide or buffers containing the same, hydrogen peroxide, sulfuric acid or buffers containing the same, mixtures of sulfuric acid and ozone, hydrofluoric acid or buffers containing the same, chromic acid or buffers containing the same, phosphoric acid or buffers containing the same, acetic acid or buffers containing the same, nitric acid or buffers containing the same, ammonium fluoride buffered hydrofluoric acid, deionized water and ozone, or combinations thereof. Strong acids such as sulfuric acid or phosphoric acid may also be used in 100% concentration.

It is also possible for the reactive chemical process fluid to contain 100% of one or more chemically reactive agents. For example, it may be desired to contact the electronic components with solvents such as acetone, N-methyl pyrrolidone, or combinations thereof. Such solvents are chemically reactive agents used, for example, to remove organics or to provide other cleaning benefits.

Cleaning fluids typically contain one or more corrosive agent such as an acid or base. Suitable acids for cleaning include for example sulfuric acid, hydrochloric acid, nitric acid, phosphoric acid, acetic acid, or aqua regia. Suitable bases include for example, ammonium hydroxide, or oxidizers such as hydrogen peroxide and ozone dissolved in water. The desired concentration of the corrosive agent in the cleaning fluid will depend upon the particular corrosive agent chosen and the desired amount of cleaning. These corrosive agents may also be used with oxidizing agents such as ozone or hydrogen peroxide. Preferred cleaning solutions are “APM” solutions containing water, ammonia, and hydrogen peroxide, and “HPM” solutions containing water, hydrogen peroxide, and hydrochloric acid. Typical concentrations for APM solutions range from about 5:1:1 to about 600:1:1 parts by volume H₂O:H₂O₂:NH₄OH. Typical concentrations for HPM solutions range from about 5:1:1 to about 1000:0:1 parts by volume H₂O:H₂O₂:HCl. Suitable etching solutions contain agents that are capable of removing oxides. A common etching agent used is for example hydrofluoric acid, buffered hydrofluoric acid, ammonium fluoride, or other substances which generate hydrofluoric acid in solution. A hydrofluoric acid containing etching solution may contain for example from about 4:1 to about 1000:1 parts by weight H₂O:HF.

One skilled in the art will recognize that there are various process fluids that can be used during wet processing. Other examples of process fluids that can be used during wet processing are disclosed in “Chemical Etching” by Werner Kern et al., in Thin Film Processes, edited by John L. Vosser et al., published by Academic Press, NY 1978, pages 401-496, which is incorporated by reference in its entirety.

The electronic component precursors 28 are optionally rinsed with a rinsing solution. As used herein, “rinsing liquid” or “rinsing fluid” refers to DI water or some other liquid or fluid that removes from the electronic components and/or processing chamber residual reactive chemical process fluids, reaction by-products, and/or particles or other contaminants freed or loosened by the chemical treatment step. The rinsing liquids or fluids may also be used to prevent redeposition of loosened particles or contaminants onto the electronic components or processing chamber. In selecting a rinsing fluid, such factors as the nature of the surfaces of the electronic components to be rinsed, the nature of contaminants dissolved in the reactive chemical process fluid, and the nature of the reactive chemical process fluid to be rinsed should be considered. Also, the rinsing fluid should be compatible (i.e., relatively non-reactive) with the materials of construction of the electronic component precursors used. Rinsing fluids which may be used include for example water, organic solvents, mixtures of organic solvents, ozonated water, or combinations thereof. Preferred organic solvents include those organic compounds useful as drying solutions disclosed hereinafter such as C₁ to C₁₀ alcohols, and preferably C₁ to C₆ alcohols. Preferably the rinsing fluid is a liquid and more preferably is deionized water. Rinsing fluids may also optionally contain low levels of chemically reactive agents to enhance rinsing. For example, the rinsing fluid may be a dilute aqueous solution of hydrochloric acid or acetic acid to prevent, for example, metallic deposition on the surface of the electronic component. Surfactants, anti-corrosion agents, and/or ozone are other additives used in rinsing fluids. The concentration of such additives in the rinsing fluid is minute. For example, the concentration is preferably not greater than about 1000 ppm by weight and more preferably not greater than 100 ppm by weight based on the total weight of the rinsing fluid. In the case of ozone, preferably the concentration of ozone in the rinsing fluid is 250 ppm or less.

One skilled in the art will recognize that the selection of reactive chemical process fluids, the sequence of reactive chemical process fluids and rinsing fluids, and the processing conditions (e.g., temperature, concentration, contact time and flow of the process fluid) will depend upon the desired wet processing results. For example, the electronic components could be contacted with a rinsing fluid before or after one or more chemical treatment steps. Alternatively, it may be desired in some wet processing methods to have one chemical treatment step directly follow another chemical treatment step, without contacting the electronic components with a rinsing fluid between two chemical treatment steps (i.e., no intervening rinse). Such sequential wet processing, with no intervening rinse, is described in for example U.S. application Ser. No. 08/684,543 filed Jul. 19, 1996, which is hereby incorporated by reference in its entirety.

After being optionally processed and rinsed, the electronic component precursors 28 are dried by contacting the precursors with the drying fluid stream. The drying fluid stream once formed, is preferably, immediately contacted with the electronic component precursors 28 in the process chamber 26 for a contact time sufficient to accomplish the desired result. By “contact time,” as used herein, it is meant the time an electronic component precursor 28 is exposed to a process fluid. For example, the contact time will include the time an electronic component precursor 28 is exposed to the process fluid during filling a processing chamber with the process fluid or immersing the electronic component precursor in the process fluid; the time the electronic component precursor is soaked in the process fluid; and the time the electronic component precursor is exposed to the process fluid while the process fluid or electronic component precursor is being removed from the processing chamber. The actual contact time chosen will also depend on such variables as the temperature, pressure, and composition of the process stream, and the composition of the surfaces of the electronic component precursors.

There are various ways in which the electronic component precursors 28 can be contacted with the drying fluid stream. Some specific embodiments of contacting the drying fluid stream with the electronic components will now be described. These embodiments are being provided as examples only and are in no way intended to limit the scope of the present invention.

The process fluid in the chamber can be substantially completely removed (i.e., drained), and then the drying fluid stream can be directed into the processing chamber during or after draining. In another embodiment, the drying fluid stream is used to directly displace the last processing solution that the electronic components are contacted with prior to drying (i.e., to as “direct displace drying”). The Omni™ wet processing system manufactured by Mattson Technology, Inc. is an example of a system capable of delivering fluids by direct displacement. Such systems are preferred because they result in a more uniform treatment of the electronic components. Additionally, often the chemicals utilized in the chemical treatment of electronic components are quite dangerous in that they may be strong acids, alkalis, or volatile solvents. Enclosable single processing chambers minimize the hazards associated with such process fluids by avoiding atmospheric contamination and personnel exposure to the chemicals, and by making handling of the chemicals safer. Suitable methods and systems for direct displace drying are also disclosed in for example U.S. Pat. Nos. 4,778,532, 4,795,497, 4,911,761, 4,984,597, 5,571,337, and 5,569,330, which are hereby incorporated by reference in their entireties. Other direct displace dryers that can be used include Marangoni type dryers supplied by manufacturers such as Mattson, Dainippon, and YieldUp.

Following drying, the electronic component precursors may be removed from the processing chamber and/or further processed in any desired manner.

Those skilled in the art will appreciate that numerous changes and modifications may be made to the preferred embodiments of the invention and that such changes and modifications may be made without departing from the spirit of the invention. It is therefore intended that the appended claims cover all equivalent variations as fall within the true scope and spirit of the invention.

What is claimed:

1. A method for processing an electronic component precursor comprising the steps of:
contacting a carrier gas with a process chemical to entrain the process chemical in the carrier gas thereby forming a fluid stream;
injecting at least a portion of additional process chemical into the fluid stream to form a localized region of increased concentration of process fluid.

2. The method of claim 1 further comprising controlling the concentration of process chemical in the localized region.

3. The method of claim 1 further comprising controlling a concentration of process chemical in the fluid stream.

4. The method of claim 1 further comprising injecting at least a portion of additional carrier gas into the fluid stream to form a diluted region of decreased concentration of process fluid.

5. The method of claim 1 wherein the portion of additional process chemical is injected into the fluid stream at selected intervals.

6. The method of claim 5 further comprising:
passing the localized region to a chamber; and
then passing the fluid stream into the chamber.

7. The method of claim 1 further comprising:
passing the fluid stream through a condenser to condense the process chemical from the carrier gas to form a condensed process fluid prior to the injection of the portion of the process chemical into the fluid stream; and
wherein the portion of the process chemical comprises condensed process fluid.

8. The method of claim 1 wherein the carrier gas comprises nitrogen.

9. The method of claim 1 wherein the process chemical comprises a drying fluid.

10. The method of claim 1 wherein the drying fluid comprises isopropyl alcohol.

11. The method of claim 1 further comprising heating the process chemical prior to the contacting of the carrier gas with the process chemical.

12. The method of claim 1 further comprising vaporizing the process chemical prior to the injection of the portion of the process chemical into the fluid stream.

13. The method of claim 7 wherein the condensed process fluid is vaporized after injection into the fluid stream.

14. A method for drying an electronic component precursor comprising the steps of:
supplying a fluid stream comprising a carrier gas;
supplying a drying fluid;
introducing at least a portion of additional drying fluid into the fluid stream to form a localized region of increased concentration of drying fluid; and
passing the localized region into a chamber.

15. The method of claim 14 further comprising controlling the concentration of drying fluid in the localized region.

16. The method of claim 15 wherein the concentration of drying fluid in the localized region is at least about 12% by weight.

17. The method of claim 15 wherein the concentration of drying fluid in the localized region is controlled to between about 12% and about 80% by weight.

18. The method of claim 14 wherein the fluid stream further comprises at least a portion of the drying fluid entrained in the carrier gas.

19. The method of claim 18 further comprising:
introducing at least a portion of additional carrier gas into the fluid stream to form a diluted region of decreased concentration of drying fluid; and
passing the diluted region into a chamber.

20. The method of claim 19 further comprising controlling a concentration of drying fluid in the carrier gas to between about 0.1 ppm and about 12% by weight.

21. The method of claim 18 further comprising:
passing the fluid stream through a condenser to condense the drying fluid from the carrier gas and form a condensed drying fluid; and
introducing at least a portion of the condensed drying fluid into the fluid stream.

22. The method of claim 14 comprising vaporizing the drying fluid prior to introducing the drying fluid into the fluid stream.

23. The method of claim 14 wherein the portion of additional drying fluid is introduced into the fluid stream at selected intervals.

24. The method of claim 14 wherein the carrier gas comprises nitrogen.

25. The method of claim 14 wherein the drying fluid comprises isopropyl alcohol.

26. The method of claim 18 wherein the drying fluid is heated prior to being entrained into the carrier gas.

27. The method of claim 22 further comprising purifying the drying fluid prior to vaporizing the drying fluid.

28. A method for drying an electronic component precursor comprising the steps of:
supplying a carrier gas;
supplying a drying fluid entrained in the carrier gas to form a fluid stream;
introducing at least a portion of additional carrier gas into the fluid stream to form a diluted region of decreased concentration of drying fluid; and
passing the diluted region into a chamber.

29. The method of claim 28 further comprising controlling the concentration of drying fluid in the diluted region.

30. The method of claim 29 further comprising controlling a concentration of drying fluid in the carrier gas to between about 0.1 ppm and about 12% by weight.

31. The method of claim 28 wherein the portion of additional carrier gas is introduced into the fluid stream at selected intervals.

32. The method of claim 28 wherein the carrier gas comprises nitrogen.

33. The method of claim 28 wherein the drying fluid comprises isopropyl alcohol.

34. The method of claim 28 wherein the drying fluid is heated prior to being entrained into the carrier gas.

35. An apparatus for processing an electronic component precursor comprising:
a carrier gas source for supplying a carrier gas;
a chemical source for supplying a process chemical;
a first manifold operatively associated with the carrier gas source for receiving a fluid stream formed by the carrier gas; and
a second manifold in fluid communication with the first manifold, for receiving the process chemical and for injecting the process chemical into the fluid stream thereby forming a localized region of increased concentration of process chemical.

36. The apparatus of claim 35 further comprising an analyzer operatively associated with the second manifold for determining the concentration of process chemical in the localized region.

37. The apparatus of claim 36 further comprising a controller operatively associated with the analyzer for controlling the concentration of process chemical in the localized region.

38. The apparatus of claim 35 further comprising a chamber operatively associated with the second manifold for receiving the localized region or the fluid stream.

39. The apparatus of claim 35 further comprising:
a vaporizer in fluid communication with the chemical source for vaporizing the process chemical and supplying a vaporized process chemical to the second manifold; and
wherein the process chemical introduced into the fluid stream comprises vaporized process chemical.

40. The apparatus of claim 35 further comprising:
a mixing module in fluid communication with the first manifold, the carrier gas source, and the chemical source for entraining the process chemical in the carrier gas wherein the fluid stream further comprises entrained process chemical.

41. The apparatus of claim 40 wherein the second manifold is in fluid communication with the carrier gas source for receiving the carrier gas and for injecting the carrier gas into the fluid stream thereby forming a diluted region of decreased concentration of process chemical.

42. The apparatus of claim 40 further comprising:
a vaporizer in fluid communication with the chemical source for vaporizing the process chemical and supplying a vaporized process chemical to the second manifold; and
wherein the process chemical introduced into the fluid stream comprises vaporized process chemical.

43. The apparatus of claim 40 further comprising:
a vaporizer in fluid communication with the second manifold for vaporizing the process chemical and supplying a vaporized process chemical to the first manifold; and
wherein the process chemical introduced into the fluid stream comprises vaporized process chemical.

44. The apparatus of claim 40 further comprising:
a condenser in fluid communication with the first manifold for receiving the fluid stream and condensing the process chemical from the fluid stream to form a condensed process fluid;
an accumulator in fluid communication with the condenser for collecting the condensed process fluid and in fluid communication with the second manifold; and
wherein the process chemical introduced into the fluid stream comprises condensed process chemical.

45. The apparatus of claim 35 wherein the carrier gas comprises nitrogen.

46. The apparatus of claim 35 wherein the process chemical comprises a drying fluid.

47. The apparatus of claim 46 wherein the drying fluid comprises isopropyl alcohol.

48. The apparatus of claim 40 comprising a heater for heating the process chemical within the mixing module.

49. The apparatus of claim 40 comprising a sparger operatively associated with the carrier gas source and the mixing module for bubbling the carrier gas through the process chemical.

50. The apparatus of claim 49 wherein the sparger comprises sintered polytetrafluoroethylene.

51. The apparatus of claim 44 further comprising:
a vaporizer operatively associated with the second manifold for vaporizing the condensed process fluid.

52. An apparatus for drying an electronic component precursor comprising:
a carrier gas source for supplying a carrier gas;
a chemical source for supplying a drying fluid;
a first manifold in fluid communication with the carrier gas source for receiving a fluid stream formed by the carrier gas;
a second manifold operatively associated with the chemical source for receiving the drying fluid and operatively associated with the first manifold for introducing the drying fluid into the fluid stream thereby forming a localized region of increased concentration of drying fluid; and
a chamber operatively associated with the first manifold and the second manifold for receiving the fluid stream and the localized region.

53. The apparatus of claim 51 further comprising an analyzer operatively associated with the second manifold for determining the concentration of process chemical in the localized region or the fluid stream.

54. The apparatus of claim 52 further comprising a controller for controlling the concentration of drying fluid in the localized region.

55. The apparatus of claim 51 wherein the fluid stream further comprises entrained drying fluid coming from a mixing module in fluid communication with the carrier gas source and the chemical source for entraining the drying fluid in the carrier gas.

56. The apparatus of claim 55 wherein the second manifold is in fluid communication with the carrier gas source for receiving the carrier gas and for injecting the carrier gas into the fluid stream thereby forming a diluted region of decreased concentration of process chemical.

57. The apparatus of claim 55 further comprising:
a condenser in fluid communication with the first manifold for receiving the fluid stream and condensing the drying fluid from the fluid stream to form a condensed drying fluid; and
an accumulator in fluid communication with the condenser for collecting the condensed drying fluid and operatively associated with the second manifold for introducing the condensed drying fluid into the fluid stream.

58. The apparatus of claim 51 comprising a vaporizer operatively associated with the chemical source for vaporizing the drying fluid.

59. The apparatus of claim 55 comprising a vaporizer operatively associated with the chemical source for vaporizing the drying fluid.

60. The apparatus of claim 57 comprising a vaporizer operatively associated with the condenser for vaporizing the condensed drying fluid.

61. The apparatus of claim 59 wherein the mixing module comprises a sparger operatively associated with the carrier gas for bubbling the carrier gas through the drying fluid.

62. The apparatus of claim 61 wherein the sparger comprises sintered polytetrafluoroethylene.

63. The apparatus of claim 59 wherein the mixing module comprises a gas-liquid contactor.

64. The apparatus of claim 63 comprising a purifier operatively associated with the vaporizer wherein the vaporizer is a flash vaporizer.

65. The apparatus of claim 51 wherein the carrier gas is nitrogen.

66. The apparatus of claim 51 wherein the drying fluid is isopropyl alcohol.

67. The apparatus of claim 55 comprising a heater for heating the drying fluid within the mixing module.
